(19) United States
(12) Patent Application Publication
(10) Pub. No.: US 2011/0209206 A1
(43) Pub. Date: Aug. 25, 2011

(54) ACCESS RESTRICTION FOR COMPUTING CONTENT

(75) Inventors: Nicolae Surpatanu, San Jose, CA (US); Yoko Sannomiya, San Jose, CA (US); Uwe Geyer, Richterswil (CH); Junmin Hao, Sunnyvale, CA (US)

(73) Assignee: MICROSOFT CORPORATION, Redmond, WA (US)

(21) Appl. No.: 12/711,139

(22) Filed: Feb. 23, 2010

(51) Int. Cl. H04L 9/32; G06F 21/00

(52) U.S. Cl. 726/7; 726/5

(57) ABSTRACT

Access restriction for computing content is provided by operating a computing device with a first profile, recognizing an attempt to log off of the first profile, and requesting a user to supply a log off credential. If the log off credential is not correct, the computing device continues to operate with the first profile, and if the log off credential is correct, the computing device operates without the first profile.

### BACKGROUND

Entertainment content can be accessed using a variety of different approaches, some of which allow unrestricted access while others provide restricted access. Restricting access to entertainment content has become more prominent in several types of use scenarios, such as scenarios where a parent wants to prevent an unauthorized child from viewing inappropriate content. Other possible use scenarios include those where multiple users share an entertainment playback device but may desire distinct entertainment environments.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, access restriction for computing content may be provided by a method which includes operating a computing device with a first profile, recognizing an attempt to log off of the first profile, and requesting a user to supply a log off credential. The method further includes, if the log off credential is not correct, continuing to operate the computing device with the first profile, and if the log off credential is correct, operating the computing device without the first profile.

### BRIEF DESCRIPTION OF THE DRAWINGS

FIG. 1 shows a flow diagram for an example method of restricting access to computing content.

FIG. 2 schematically shows an example multimedia computing system in accordance with an embodiment of the present disclosure.

FIG. 3 schematically shows an example of associating computing content with a user profile in accordance with an embodiment of the present disclosure.

FIG. 4 schematically shows another example of associating computing content with a user profile in accordance with an embodiment of the present disclosure.

FIG. 5 schematically shows yet another example of associating computing content with a user profile in accordance with an embodiment of the present disclosure.

### DETAILED DESCRIPTION

Access to computing content is oftentimes restricted using a log in procedure, where a user must authenticate oneself before being allowed access to the computing content. Typically each user of a computing system has a user profile associated with the user, to which the user's preferences, files, etc. are tied, and the user can access her profile by providing identification such as a username and password. As such, a user who cannot provide her username and password is restricted from accessing content tied to her profile. However, in the case of a user being a young child who may not be capable of providing such log in information, a parent may set up the child's profile and log the child in as needed. However, this may be inconvenient for the parent in that if the child accidently logs off of the computer, shuts down the computer, etc., the parent will then have to log the child back into the computer again. Further, a user who is unable to log in to any profile while the computer is not already logged on to a profile may be stuck in an environment where he cannot access any content. Restricting access to computing content as described herein restricts a user from exiting the present environment which is tied to a profile unless the user can provide a correct log off credential. As such, access restriction is then tied to log off credentials as opposed to the traditional approach of tying access restriction to log on credentials.

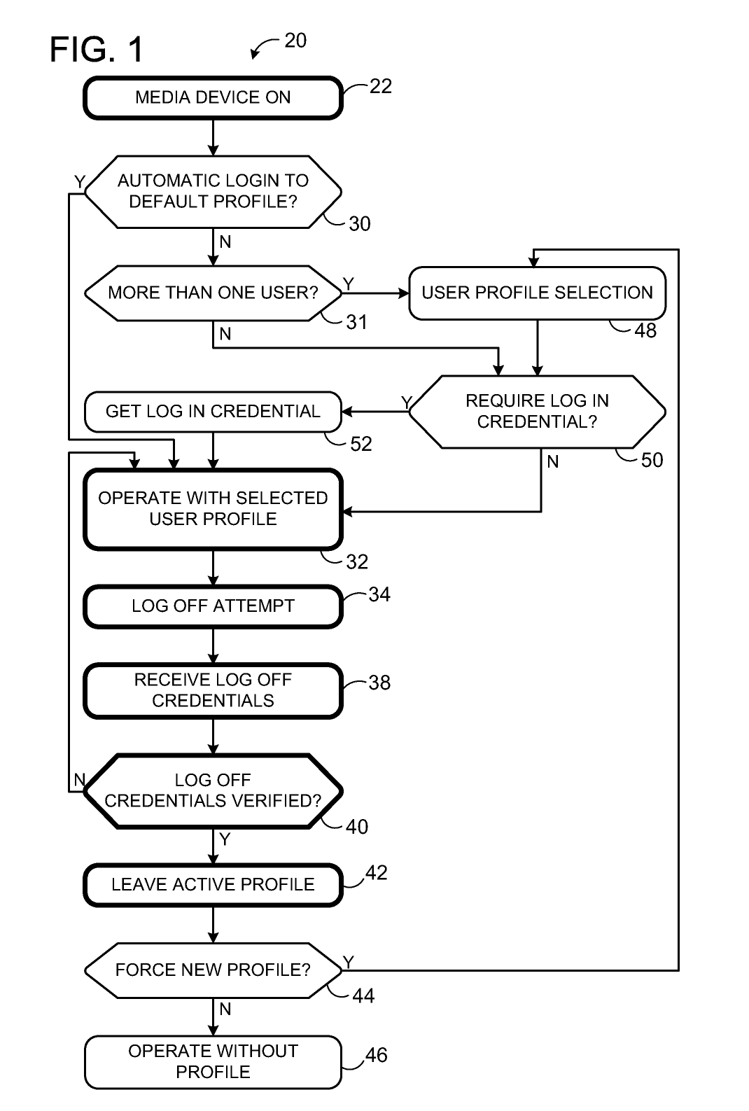

FIG. 1 shows an example method 20 of restricting access to computing content. In some embodiments, method 20 may be used to restrict access to computing content on a media device, such as a set top box, a portable media player, a media center computer, a gaming console, or another device capable of playing entertainment content. As such, computing content may include audio-visual programming such as movies, television (e.g., analog television, digital television, Internet Protocol television (IPTV), etc.), video games, and the like. While method 20 is described in the context of a media device restricting access to entertainment content, method 20 is not limited to such a scenario. Method 20 may additionally or alternatively be used to restrict access to virtually any other type of computing content on virtually any type of computing device that supports one or more profiles.

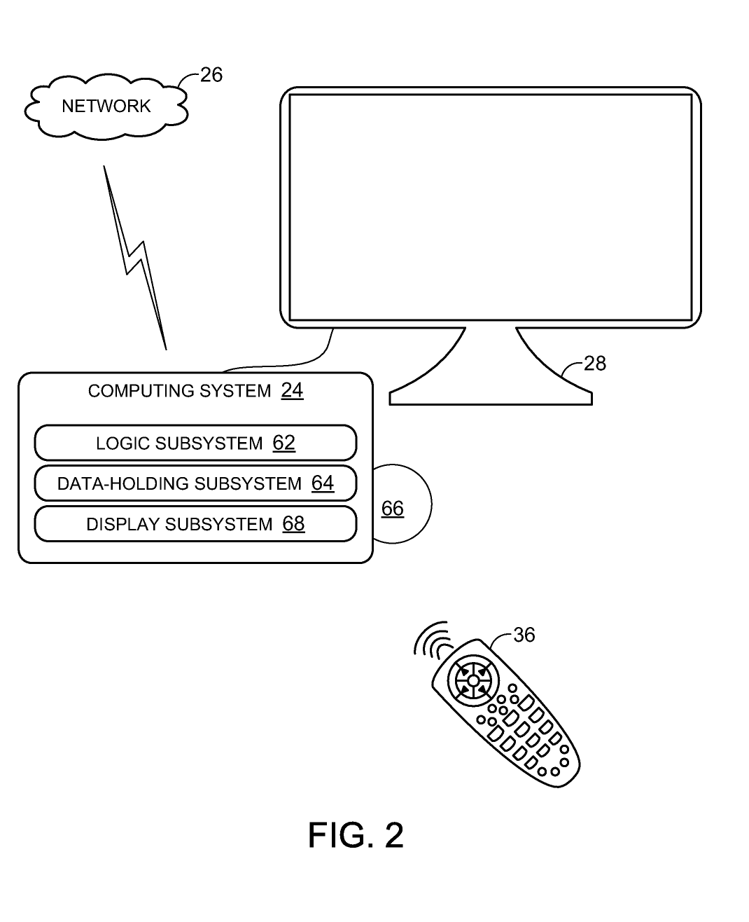

At 22, method 20 includes the media device being in an “on” state. FIG. 2 shows an example multimedia computing device, i.e. media device 24, configured to receive multimedia programming from network 26 and display the programming on display 28.

Returning to FIG. 1, at 30, if there is an automatic login to a default profile, method 20 proceeds to 32. For example, in some embodiments, a media device may be set up to have a default profile, such that when the device is turned on, the default profile is automatically logged into.

At 32, method 20 includes operating the media device with the selected profile. This may include playing programming that is not restricted by the selected user profile, which in this case is the default profile. For example, a profile may be associated with selected audio-visual programming indicated as allowable (i.e., whitelisted), such that operating the media device with the profile allows access to such content. The profile may also be associated with selected audio-visual programming indicated as not allowable (i.e., restricted, not whitelisted, etc.), such that operating the media device with the profile restricts access to such content. As a nonlimiting example, the profile may be a child profile and operating the media device with the child profile includes restricting access to audio-visual programming having adult content.

The profile may control access (i.e., allow or restrict access) to content in any suitable manner. As an example, the profile may indicate content-related properties that are allowable or restricted. Such properties may correspond to the metadata of the content, and/or to the content itself. For example, such properties may include a series name, episode name, movie name, etc. as well as content-descriptors such as a subject matter, a program rating (e.g., a suggested audience rating, a parental guideline rating, etc.) and the like. As another example, a profile may indicate programming-related properties that are allowable or restricted, such as a channel descriptor (e.g., channel number, channel name, channel category, etc.), a programming time slot, etc.

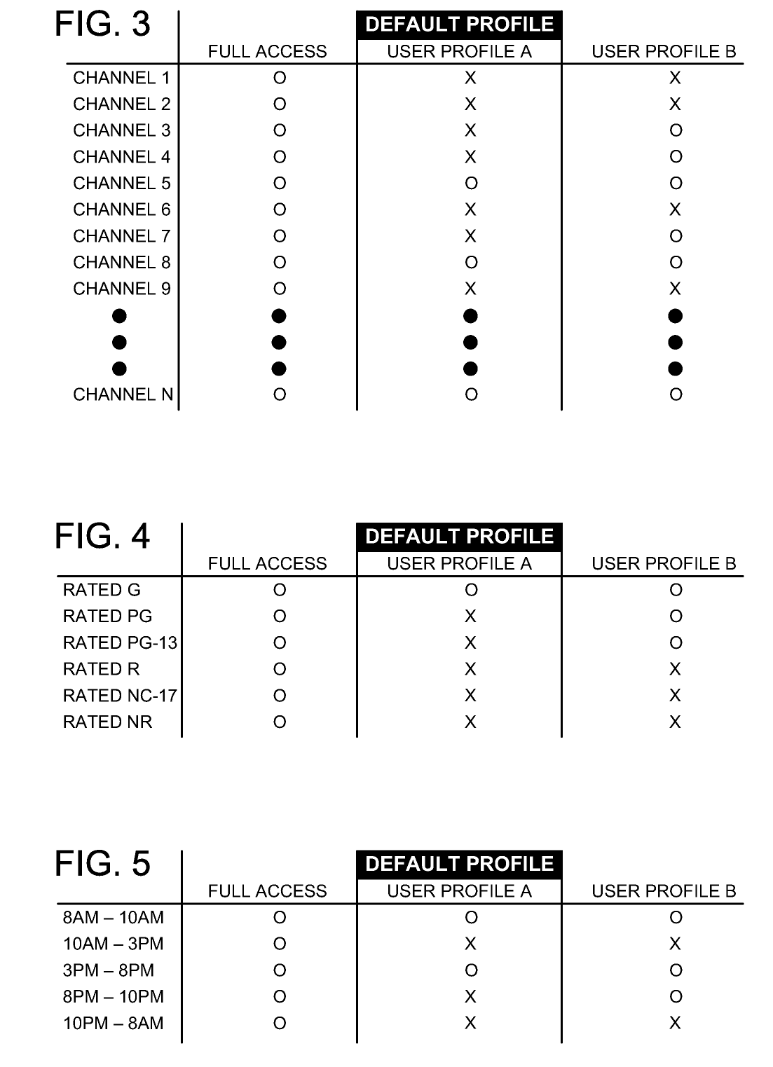

As a nonlimiting example of associating computing content with a profile, a child profile may allow access to audio-visual programming of three children's network channels at any time, and one general network channel on Saturday mornings. As another example, a child profile may allow programming having content with a child-appropriate rating and restrict all programming having content with an adult rating. Examples of associating computing content with a user profile are described in more detail with reference to FIGS. 3-5.

Continuing with FIG. 1, at 34, method 20 includes recognizing an attempt to log off of the profile. As an example, such an attempt may include receiving a request to change a channel of the programming being presented by the media device to a restricted channel. As another example, the attempt may include receiving a selection of an exit or log off button within a user interface being visually presented to the user on a display. As yet another example, the attempt may include receiving a selection to switch to a different user profile.

In the case of example media device 24 shown in FIG. 2, media device 24 may be configured to receive a log off attempt via a remote control 36. In the case of the examples introduced above, a user may press a channel key, or type in a channel number on a numeric keypad, to signal a log off attempt to media device 24. As another example, display 28 may present a user interface having an exit button, a “change user” button, etc. that the user may select via remote control 36 which signals a log off attempt to media device 24.

Returning to FIG. 1, at 38, method 20 includes receiving one or more log off credentials. Such log off credentials may be supplied by a user upon making a log off attempt. Examples of log off credentials include, but are not limited to, a personal identification number, a password, a passcode, a passphrase, verification of a biometric parameter, and the like. For the case of the example media device shown in FIG. 2, such log off credentials may be provided by the user via remote control 36. As will be described in more detail hereafter, in some embodiments log off credentials received at 38 may not only allow a user to log off of an active profile, but such log off credentials may further indicate which profile is to be subsequently selected.

At 40, method 20 includes determining if the log off credentials are verified. As an example, the received log off credentials may be compared to known credentials associated with the selected user profile. If the log off credentials are not verified, then method 20 proceeds to 32 and continues to operate the media device with the selected user profile. However, if the credentials are verified, then method 20 proceeds to 42.

At 42, method 20 includes leaving the active profile. In other words, a user is allowed to leave the current viewing environment which is associated with the active profile. For example, a parent is allowed to leave the restricted viewing environment to access adult content.

In some embodiments, the media device is configured to always run an active profile, while in other embodiments, the media device may be allowed to operate without an active profile. As such, upon leaving the active profile, method 20 may proceed to 44. If a new profile is not forced at 44, then method 20 proceeds to 46 and the media device is allowed to operate without a profile. In some embodiments, operating without a profile may include operating the media device without any programming restrictions (e.g., full access to all channels). For example, a child profile may be the only profile set up for the media device, such that operating the media device without the child profile allows access to all programming.

Alternatively, if upon leaving the active profile, a new profile is forced, then method 20 proceeds to 48, where a user profile may be selected. As an example, the media device may have two or more profiles, such that upon leaving one of the profiles, a user may select another profile, or the media device may automatically select an alternate profile based on a user selected preference (e.g., automatically default to parent profile after logging out of child profile). As another example, log off credentials received at 38 may indicate which profile is forced (i.e., automatically selected at 48). For example, a parent may log off of a child profile with their credentials, which indicates that the parent's profile is selected at 48, allowing access to adult programming such as R-rated movies. As another example, a teenager may log off of a child profile with their credentials, which indicates that the teenager's profile is selected at 48, allowing access to teen programming such as PG and PG-13-rated movies but restricts access to R-rated movies. In other words, log off credentials received at 38 may not only allow a user to leave an active profile, but may also indicate which profile is to be forced upon the log off. Upon selecting the profile at 48, method 20 proceeds to 50.

Selection of a user profile at 48 may alternatively be reached if initially there is no automatic login to a default profile. For example, in some embodiments, a media device may not have a default profile, such that when the device is turned on, no profile is automatically logged into. In that case, method 20 proceeds to 31. At 31, if there is more than one user, then method 20 proceeds to 48 and a user is selected. As an example, upon turning on the media device, rather than automatically logging into a default profile, the media device may alternatively display a menu listing possible user profiles available for selection. A user may then select a user profile. Alternatively, if there is not more than one user, then the profile corresponding to the one user is selected and method 20 proceeds from 31 to 50.

For embodiments where a log in credential is not required, method 20 proceeds from 50 to 32, and the media device operates with the selected user profile. Alternatively, for embodiments where a log in credential is required (e.g., the selected user profile is associated with a log in credential), method 20 proceeds from 50 to 52, and the log in credential is obtained, allowing method 20 to proceed to 32, where the media device operates with the selected user profile.

It can be appreciated that a log in credential for a user profile may be decoupled from a log off credential for the user profile. As an example, a user profile may have different log in credentials than log off credentials.

FIG. 3 schematically shows an example of associating computing content with various user profiles. For example, User Profile A restricts channels 1-4, 6-7, 9, etc. and allows channels 5 and 8. In the context of User Profile A being a default profile, a use scenario for a method of restricting access to computing content, such as method 20, is as follows. Upon turning a media device on, the media device operates with the default profile, namely User Profile A. As such, the media device can play programming corresponding to channel 5 or channel 8. As an example, User Profile A may be a child profile set up by a parent, allowing the child to watch channels 5 and 8 that play children-related programming. As such, the child can freely change between channels 5 and 8, turn the TV off and on, etc. and still be able to view the children-related programming. However, the child may not access any other channels without providing log off credentials that can be verified. In some embodiments, program guides and other features associated with restricted content may be hidden unless log off credentials are verified.

If the media device receives a log off attempt, for example a request to change the channel to channel 3, the user may be prompted to provide log off credentials to leave the child profile. If the channel was changed by the child who does not have the credentials, the log off credentials would not be verified, and thus the media device would continue to operate in the selected child profile. However, if the channel was changed by the parent, the parent could then provide the credentials, allowing the media device to log off of the child profile.

FIG. 4 schematically shows another example of associating computing content with various user profiles, wherein content is associated with a given profile based on a rating. In this example, User Profile A can allow children-related programming by allowing content rated G, and restricting content having any other rating. Upon turning a media device on, the media device operates with the default profile, namely User Profile A. As such, the media device can play programming corresponding to a G rating. Thus, a child may freely change between any channel which is playing programming having a G rating, turn the TV off and on, etc.

If the media device receives a log off attempt, for example a request to change the channel to programming rated R, the user may be prompted to provide log off credentials to leave the child profile. If the channel was changed by the child who does not have the credentials, the log off credentials would not be verified, and thus the media device would continue to operate in the selected child profile corresponding to G-rated programming. However, if the channel was changed by the parent, the parent could then provide the credentials, allowing the media device to log off of the child profile and then view the programming having an R rating. Alternatively, the parent may have set up additional profiles including a User Profile B for their teenager which allows further access to programming having PG or PG-13 ratings but still does not allow R-rated programming. In such embodiments, the teenager profile may be automatically selected (e.g., via 44 and 48 of method 20 of FIG. 1) based on the log off credential provided by the teenager.

FIG. 5 schematically shows yet another example of associating computing content with various user profiles, wherein content is associated with a given profile based on a time slot. In this example, User Profile A can allow children-related programming by allowing content playing between 8 AM and 10 AM, such as cartoons, and content playing between 3 PM and 8 PM, such as after-school programming and family-oriented programming, while blocking all content at other times.

The content restrictions provided with reference to FIGS. 3-5 are only examples, and virtually any other restrictions may be used without departing from the scope of this disclosure.

The above described methods and processes may be tied to a computing system, such as media device 24 shown in FIG. 2. Media device 24 may be configured to perform one or more of the above described methods and processes. Media device 24 includes a logic subsystem 60 and a data-holding subsystem 62. Media device 24 may optionally include other components not shown in FIG. 2.

Logic subsystem 60 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 62 may include one or more physical, non-transitory, devices configured to hold data and/or instructions executable by the logic subsystem to implement the herein described methods and processes. When such methods and processes are implemented, the state of data-holding subsystem 62 may be transformed (e.g., to hold different data). Data-holding subsystem 62 may include removable media and/or built-in devices. Data-holding subsystem 62 may include optical memory devices, semiconductor memory devices, and/or magnetic memory devices, among others. Data-holding subsystem 62 may include devices with one or more of the following characteristics: volatile, nonvolatile, dynamic, static, read/write, read-only, random access, sequential access, location addressable, file addressable, and content addressable. In some embodiments, logic subsystem 60 and data-holding subsystem 62 may be integrated into one or more common devices, such as an application specific integrated circuit or a system on a chip.

FIG. 2 also shows an aspect of the data-holding subsystem in the form of computer-readable removable media 66, which may be used to store and/or transfer data and/or instructions executable to implement the herein described methods and processes.

When included, display subsystem 68 may be used to present a visual representation of data held by data-holding subsystem 62. As the herein described methods and processes change the data held by the data-holding subsystem, and thus transform the state of the data-holding subsystem, the state of display subsystem 68 may likewise be transformed to visually represent changes in the underlying data. Display subsystem 68 may include one or more display devices utilizing virtually any type of technology. Such display devices may be combined with logic subsystem 60 and/or data-holding subsystem 62 in a shared enclosure, or such display devices may be peripheral display devices. In the illustrated example, display subsystem 68 includes high definition display 28.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of restricting access to computing content, comprising:
operating a computing device with a first profile;
recognizing an attempt to log off of the first profile;
requesting a user to supply a log off credential;
if the log off credential is not correct, continuing to operate the computing device with the first profile; and
if the log off credential is correct, operating the computing device without the first profile.

2. The method of claim 1, where the first profile is a child safe profile restricting access to adult content.

3. The method of claim 2, where operating the computing device without the first profile includes allowing access to the adult content.

4. The method of claim 1, where requesting the user to supply the log off credential includes requesting the user to enter a personal identification number.

5. The method of claim 1, further comprising automatically logging in to the first profile without requiring a log in credential when the computing device is turned on.

6. The method of claim 1, where the computing device is a media device configured to play audio-visual programming.

7. The method of claim 1, where operating the computing device without the first profile includes allowing access to adult content.

8. The method of claim 1, where operating the computing device without the first profile includes operating the computing device with a second profile, the second profile selected based on the log off credential.

9. A method of restricting access to media content on a media device, comprising:
operating the media device with a first user profile, the first user profile restricting access to a first type of media content;
recognizing an attempt to access the first type of media content;
requesting a user to supply a log off credential to log off of the first user profile;
recognizing the log off credential supplied by the user;
if the log off credential is not correct, continuing to operate the media device with the first user profile and restricting access to the first type of media content; and
if the log off credential is correct, operating the media device without the first user profile and allowing access to the first type of media content.

10. The method of claim 9, where the media device is configured to play audio-visual programming, and where the first type of media content includes audio-visual programming with an adult rating.

11. The method of claim 9, where the media device is configured to play audio-visual programming, and where the first type of media content includes audio-visual programming received from a restricted channel.

12. The method of claim 9, where the media device is configured to play audio-visual programming, and where the first type of media content includes audio-visual programming received during a restricted time period.

13. The method of claim 9, where the media device is configured to play audio-visual programming, and where the first type of media content includes audio-visual programming that is not whitelisted.

14. The method of claim 9, where requesting the user to supply the log off credential includes requesting the user to enter a personal identification number.

15. The method of claim 9, further comprising automatically logging in to the first user profile without requiring a log in credential when the media device is turned on.

16. The method of claim 9, further comprising requesting a user to select a user profile when the media device is turned on, and requiring a verified log in credential to access the first type of media content.

17. The method of claim 9, where operating the media device without the first user profile and allowing access to the first type of media content includes operating the media device without a user profile.

18. The method of claim 9, where operating the media device without the first user profile and allowing access to the first type of media content includes operating the media device with a second user profile, the second user profile allowing access to the first type of media content.

19. The method of claim 18, where the second profile is selected based on the log off credential.

20. A multimedia computing device, comprising:
a logic subsystem to execute instructions; and
a data-holding subsystem holding instructions executable by the logic subsystem to:
operate the multimedia computing device with a first user profile, the first user profile restricting access to a first type of media content;
recognize an attempt to access the first type of media content;
request a user to supply a log off credential to log off of the first user profile;
recognize the log off credential supplied by the user;
if the log off credential is not correct, continue to operate the multimedia computing device with the first user profile and restrict access to the first type of media content; and
if the log off credential is correct, operate the multimedia computing device without the first user profile and allow access to the first type of media content.
